(19) United States
(12) Patent Application Publication
(10) Pub. No.: US 2016/0375776 A1
(43) Pub. Date: Dec. 29, 2016

(54) RANGE EXTENDER AND CHARGING CONTROL METHOD, POWER GENERATION EQUIPMENT AND CONTROL METHOD FOR POWER GENERATION EQUIPMENT

(71) Applicant: INDUSTRIAL TECHNOLOGY RESEARCH INSTITUTE, HSINCHU (TW)

(72) Inventors: Jung-Sheng WEN, Taipei (TW); Chi-Cheng WANG, Taoyuan (TW); Chi-Hsu WANG, Hsinchu (TW); Ming-Une JEN, Hsinchu County (TW); Ming-Hung LU, Zhubei City (TW)

(21) Appl. No.: 14/875,407

(22) Filed: Oct. 5, 2015

(30) Foreign Application Priority Data
Jun. 26, 2015 (TW) 104120771

(51) Int. Cl. B60L 11/12; H02P 9/00

(52) U.S. Cl. CPC B60L 11/126; H02P 9/008

(57) ABSTRACT

A control method for a power generation equipment is provided. The control method for a power generation equipment is adapted to a power generation equipment driving the generator by the engine. First, determining the initial time of the combustion stroke in an internal combustion engine cycle according to at least one sensing signal. Then, controlling the generator to output electric power with a first current in a first time interval starting from the initial time of the combustion stroke is performed. And, controlling the generator output electric power with a second current after the first time interval is performed. The second current is greater than the first current.

### CROSS-REFERENCE TO RELATED APPLICATIONS

This non-provisional application claims priority under 35 U.S.C. §119(a) on Patent Application No. 104120771 filed in Taiwan, R.O.C. on Jun. 26, 2015, the entire contents of which are hereby incorporated by reference.

### BACKGROUND

Technical Field

The present disclosure relates to a range extender for electric vehicles, a charging control method for the range extender, a power generation equipment, and a control method for the power generation equipment.

Description of the Related Art

Range extender technology is a promising solution to resolve the driving range concern of electric vehicles (EVs). Among different principles and configurations used for range extenders, piston-engine based genset is the mainstream and the most common one due to the relative low production cost and fast time to market. Piston-engine based genset, however, has the worst noise and vibration performance because of the large torque variations during combustion cycles of the engine.

In the prior art, torsional damper type flywheel, roll moment compensation or torque command compensation are mostly applied to the designs, and corresponding modifications of engines and gensets to control the vibration of electric vehicles including hybrid electric vehicles (HEVs). As a result, the design or control scheme is more complicated and may lead to the increase of manufacturing cost.

### SUMMARY

A control method for a power generation equipment having an engine to drive a generator includes determining an initial time of a combustion stroke in an internal combustion engine cycle according to at least one sensing signal of the engine, controlling the generator to output electric power with a first current in a first time interval starting from the initial time of the combustion stroke, and controlling the generator to output electric power with a second current after the first time interval.

A power generation equipment includes an engine, a generator, and a controller. The engine is for outputting kinetic power. The generator is coupled to the engine, and is for transforming kinetic power output from the engine into electric power. The controller is electrically connected to the engine and the generator, and is for determining an initial time of a combustion stroke in an internal combustion engine cycle according to at least one sensing signal of the engine, controlling the generator to output electric power with a first current in a first time interval starting from the initial time of the combustion stroke, and controlling the generator to output electric power with a second current after the first time interval.

A charging control method applies to a range extender. The range extender includes a battery, an engine, a generator, and a controller. In that range extender, the engine drives the generator to charge the battery. The charging control method includes the controller determining an initial time of a combustion stroke in an internal combustion engine cycle according to at least one sensing signal of the engine, the controller controlling the generator to charge the battery with a first current in a first time interval starting from the initial time of the combustion stroke, and the controller controlling the generator to charge the battery with a second current after the first time interval.

A range extender includes a battery, an engine, a generator, and a controller. The battery is for storing electric power and driving a range extended electric vehicle, or a hybrid electric vehicle, or a plug-in hybrid electric vehicle with stored electric power. The engine is for outputting kinetic power. The generator is coupled to the engine and electrically connected to the battery, and is for transforming kinetic power output from the engine into electric power to charge the battery. The controller is electrically connected to the engine and the generator, and is for determining an initial time of a combustion stroke in an internal combustion engine cycle according to at least one sensing signal of the engine, controlling the generator to charge the battery with a first current in a first time interval starting from the initial time of the combustion stroke, and controlling the generator to charge the battery with a second current after the first time interval.

The contents of the present disclosure set forth and the embodiments hereinafter are for demonstrating and illustrating the spirit and principles of the present disclosure, and for providing further explanation of the claims.

### BRIEF DESCRIPTION OF THE DRAWINGS

The present disclosure will become more fully understood from the detailed description given hereinbelow and the accompanying drawings, which are given by way of illustration only and thus are not limitative of the present disclosure and wherein:

FIG. 1 is a functional block diagram of the power generation equipment according to an embodiment;

FIG. 2 is a diagram of the generated current of the power generation equipment and the cylinder pressure of the single cylinder four-stroke engine relative to time according to an embodiment;

FIG. 3 is a diagram of the generated power of the power generation equipment and the cylinder pressure of the single cylinder four-stroke engine relative to time according to an embodiment;

FIG. 4 is a time signature analysis diagram of the engine vibration of the power generation equipment according to an embodiment;

FIG. 5 is an order analysis diagram of the engine vibration of the power generation equipment according to an embodiment;

FIG. 6 is a flowchart of the control method of the power generation equipment according to an embodiment;

FIG. 7 is a functional block diagram of the range extender according to an embodiment;

FIG. 8 is a functional block diagram of the range extender according to another embodiment; and

FIG. 9 is a flowchart of the charging control method of the range extender according to an embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

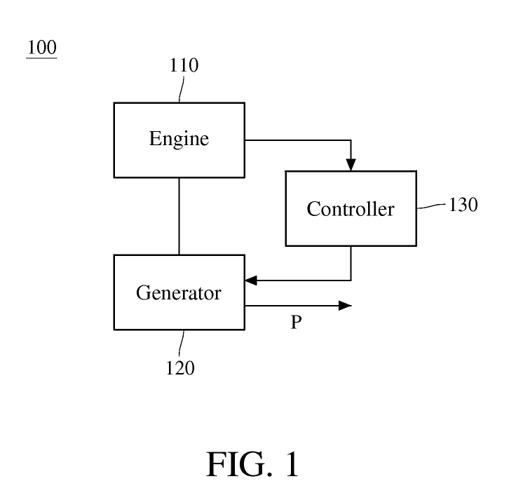

Please refer to FIG. 1. FIG. 1 is a functional block diagram of the power generation equipment according to an embodiment. As shown in FIG. 1, the power generation equipment 100 has an engine 110, a generator 120, and a controller 130. The generator 120 is coupled to the engine 110. The controller 130 is electrically connected to the engine 110 and the generator 120.

The engine 110 is for outputting kinetic power by rotating the output shaft. The engine 110 is, but not limited to, a four-stroke engine or a two-stroke engine. When the engine 110 is a four-stroke engine, the engine 110 performs the four strokes of intake, compression, combustion, and exhaust with the four strokes of the piston. When the engine 110 is a two-stroke engine, the engine 110 performs the four strokes of intake, compression, combustion, and exhaust with the two strokes of the piston. Therefore, the output shaft rotates two turns in the time interval of a four-stroke cycle, and the output shaft rotates one turn in the time interval of a two-stroke cycle. For clearer explanation, the output shaft rotating one turn is defined as one operating cycle of the piston of the engine 110, and unit time interval T is defined as the period of the output shaft of the four-stroke engine 110 rotating two turns or the period of the output shaft of the two-stroke engine 110 rotating one turn. In the process of the combustion stroke, the mixture of air and fuel vapour was ignited for combustion to generate output kinetic power. At the same time, the torque of the engine 110 varies dramatically which induces the rapid vibration increase of power generation equipment 100. The cylinder pressure reaches the maximum during the combustion stroke.

In practice, for a certain cylinder of a four-stroke engine, the firing frequency and the frequency of fuel injection maybe the same or different. In an embodiment, a certain cylinder of the engine 110 is ignited in every operating cycle of the piston but fuel injection is performed once in every two operating cycles of the piston. Therefore, a certain cylinder of the engine 110 performs a combustion stroke in every two operating cycles. In another embodiment, a certain cylinder of the engine 110 is ignited and fuel injection is performed in every two operating cycles of the piston, thus a certain cylinder of the engine 110 performs a combustion stroke in every two operating cycles.

The generator 120 is driven by the kinetic power output from the engine 110 to transform the kinetic power into electric power. The generator 120 is, for example, an integrated starter generator (ISG). The controller 130 is for determining an initial time of a combustion stroke in an internal combustion engine cycle according to at least one sensing signal. The at least one sensing signal can be an ignition signal of the engine, a fuel injection signal of the engine, a crankshaft position and a camshaft position sensor signal of the engine, an air intake pressure sensor signal of the engine, or a cylinder pressure signal of the engine. In other words, the controller 130 performs vibration control according to the power generation needs of the power generation equipment 100 and the initial time of the combustion stroke in an internal combustion engine cycle of the engine 110.

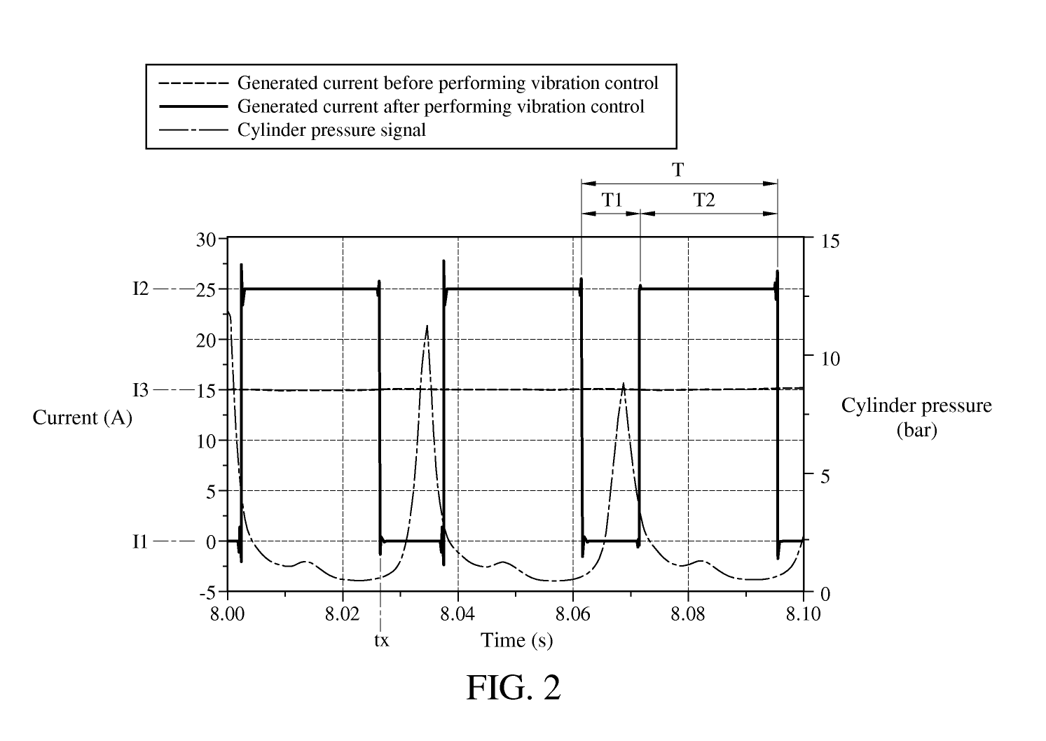

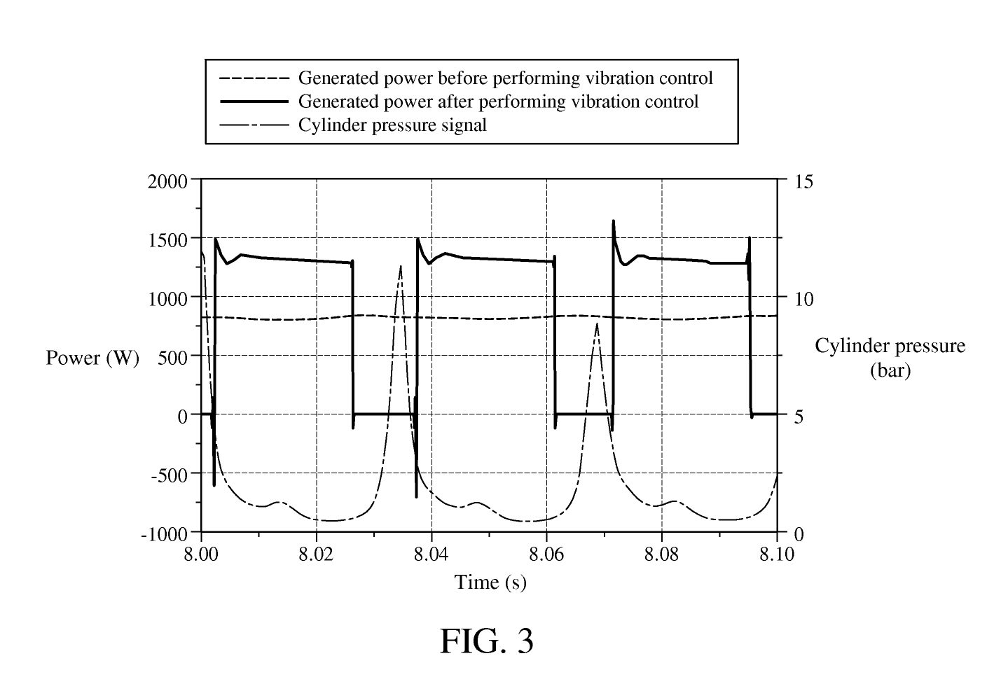

Please refer to FIG. 2 and FIG. 3 for explaining the vibration control of the controller 130 more specifically. FIG. 2 is a diagram of the generated current of the power generation equipment and the cylinder pressure of the single cylinder four-stroke engine relative to time according to an embodiment. FIG. 3 is a diagram of the generated power of the power generation equipment and the cylinder pressure of the single cylinder four-stroke engine relative to time according to an embodiment. As shown in FIG. 2, the generated current before performing the vibration control is illustrated with a dotted line, and the generated current after performing the vibration control is illustrated with a solid line, and the cylinder pressure signal is illustrated with a central line. The cylinder pressure signal corresponds to the cylinder pressure is illustrated on the right side of the vertical axis and the measurement unit is bar. The generated current, before and after performing the vibration control, is illustrated on the left side of the vertical axis and the measurement unit is Ampere. As shown in FIG. 3, the generated power before performing the vibration control is illustrated with a dotted line, and the generated power after performing the vibration control is illustrated with a solid line, and the cylinder pressure signal is illustrated with a central line. The cylinder pressure signal corresponds to the cylinder pressure is illustrated on the right side of the vertical axis and the measurement unit is bar. The generated power, before and after performing the vibration control, is illustrated on the left side of the vertical axis and the measurement unit is watt.

In an embodiment, according to the ignition signal of a certain cylinder of the engine 110, the controller 130 determines the initial time tx of the combustion stroke in an internal combustion engine cycle of the engine 110, and the controller 130 controls the generator 120 to output electric power with a first current I1 in a first time interval T1 starting from the initial time of the combustion stroke in an internal combustion engine cycle, and controls the generator 120 to output electric power with a second current I2 after the second time interval T2. The second current I2 is greater than the first current I1. When the engine of the power generation equipment has two or more cylinders, controlling output electric power of each of the combustion stroke of a certain cylinder, part of the cylinders, or all of the cylinders can be performed. The first time interval T1 is the total time of outputting electric power with the first current I1, and the second time interval T2 is the total time of outputting electric power with the second current I2. The unit time interval T is the sum of the first time interval T1 and the second time interval T2.

As shown in FIG. 2, the cylinder pressure of the engine 110 increases rapidly and dramatically during the combustion stroke and reaches the maximum. Therefore, from another perspective, the controller 130 controls the generator 120 to output smaller generated current in the time intervals close to the maximum of the cylinder pressure, and the controller 130 controls the generator 120 to output larger generated current in the time intervals with smaller cylinder pressure. Therefore, in another embodiment, the controller 130 determines the initial time of the combustion stroke in an internal combustion engine cycle of the engine 110 according to the cylinder pressure signal. More specifically, the controller 130 compares the cylinder pressure increasing rate of the cylinder pressure signal with the cylinder pressure increasing rate threshold dP/dt. When the controller 130 determines that the cylinder pressure increasing rate of the cylinder pressure signal is greater than the cylinder pressure increasing rate threshold dP/dt, the controller 130 further determines that the instant is the initial time of the combustion stroke and performs the current control.

In fact, the sensing signal is defined according to the engine structure by persons skilled in the art after reading the present disclosure, and the method determining the initial time of the combustion stroke in an internal combustion engine cycle according to the engine structure belongs to the present disclosure.

Corresponding to the relationship between the output current and the cylinder pressure, there is also a similar relationship between the output power and cylinder pressure of the generator 120. More specifically, the controller 130 controls the generator 120 to output smaller power in the time intervals close to the maximum of the cylinder pressure, as shown in FIG. 3, and the controller 130 controls the generator 120 to output larger power in the time intervals with smaller cylinder pressure.

In an embodiment, the controller 130 performs fuzzy logic operation according to the sensing signal to determine the initial time and the duration of the first time interval T1 and control the generator 120 to output electric power with the first current I1 in the first time interval T1 accordingly and control the generator 120 to output electric power with the second current I2 after the first time interval T1. In practice, according to different rules of fuzzy logic operation, the first time interval T1 is, for example, a short time interval during the engine 110 combustion stroke, or a short time interval during the fuel injection to the engine 110, or a short time interval determined by using the signals from the crankshaft position sensor and the camshaft position sensor of the engine 110 for indicating the combustion stroke of the cylinder, or a short time interval determined by using the signal from the air intake pressure sensor of the engine 110 for indicating the combustion stroke in an internal combustion engine cycle, or a short time interval during the cylinder pressure of the engine 110 reaches the maximum. The unit time interval T is the sum of the first time interval T1 and the second time interval T2.

The duration of the first time interval T1 and the duration of the second time interval T2 are related to the rotation speed and the number of cylinders for controlling the vibration of the engine 110. In other words, the duration of the first time interval T1 and the duration of the second time interval T2 are related to the unit time interval T and the number of cylinders for controlling the vibration of the engine 110. More specifically, when the rotation speed of the engine 110 is 3600 revolutions per minute (rpm), the time for each revolution is 1/60 second and the unit time interval T includes one or two revolutions of the engine 110 depending on whether the engine 110 is two-stroke or four-stroke. When the engine of the power generation equipment has two or more cylinders, controlling output electric power of each of the combustion stroke of a certain cylinder, part of the cylinders, or all of the cylinders can be performed. The first time interval T1 is the total time of outputting electric power with the first current I1. Taking a single cylinder four-stroke engine with 3500 rpm rotation speed for example, the duration of the unit time interval T is 34 mini-second (ms) and the duration of the first time interval T1 is between 2 ms and 10 ms. In an embodiment, the duration of the first time interval T1 is directly proportional to the unit time interval T. In another embodiment, the duration of the first time interval T1 is set to a fixed value according to the needed vibration suppression effect in practice.

Extending from the aforementioned explanation, because the first current I1 is less than the second current I2, when the first current I1 is zero, the amount of the second current I2 is determined according to a preset current value and the duration of the first time interval T1 in order to equalize the average current before and after performing the vibration control, that is, the third current I3. The preset current value is equal or close to the third current I3. For example, when the rotation speed of a single cylinder four-stroke engine is 3600 rpm, the preset current value is 15 ampere and the duration of the first time interval T1 is 10 ms. Therefore, the second current value I2 is 15×1/30÷(1/30−1/100)=21.4 ampere. In another embodiment, the first current I1 is not zero, and the value of the first current I1 and the value of the second current I2 are determined according to the preset current value and the duration of the first time interval T1. The details can be deduced by analogy and are not further explained hereinafter.

In other embodiment, the second current I2 is less than the preset current value to fulfill different needs. For example, the power generation equipment 100 is applied to an electric vehicle and when the power generation equipment 100 performs power generation activation or deactivation procedure, the power generation control gradually increases or gradually decreases the current to reach the preset current value in a set time interval. To compromise between the loading and the vibration suppression effect, the power generation equipment 100 outputs the second current I2 less than the preset current value in this kind of situation for supplying the preset current value.

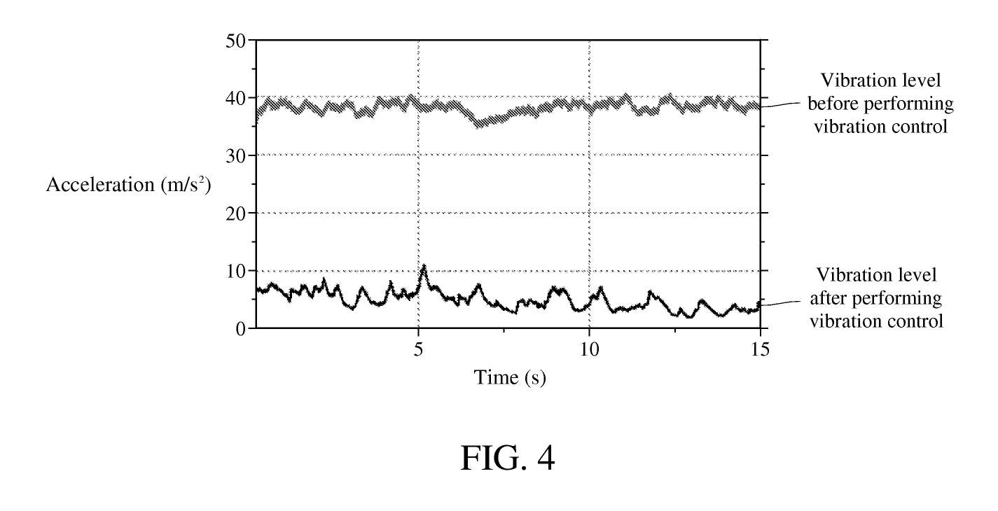

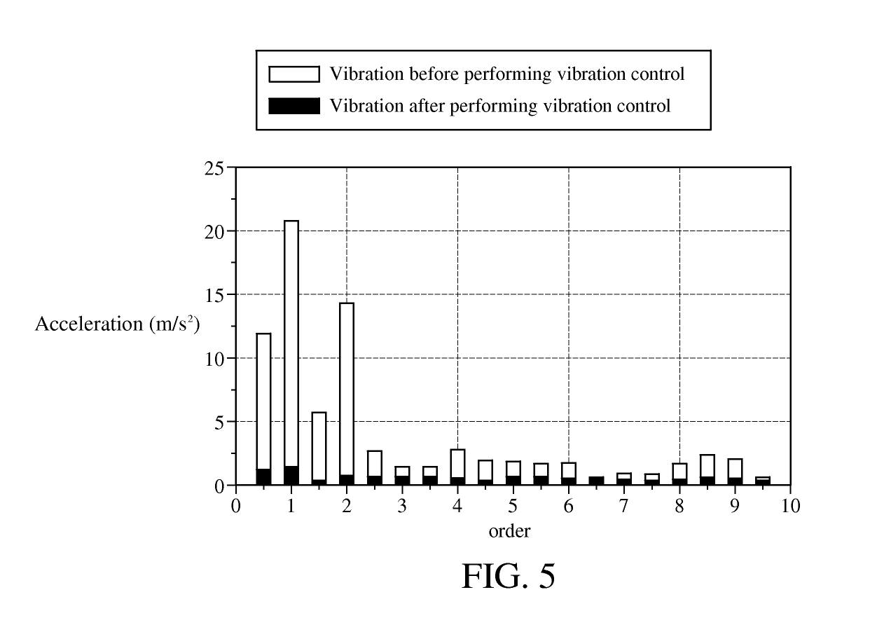

By outputting different currents or powers in different time intervals selectively according to the aforementioned explanation, the vibration of the power generation equipment 100 is suppressed. Please refer to FIG. 4 and FIG. 5 for the validation of the aforementioned vibration suppression effect. FIG. 4 is a time signature analysis diagram of the engine vibration of the power generation equipment according to an embodiment. FIG. 5 is an order analysis diagram of the engine vibration of the power generation equipment according to an embodiment. The overall vibration level of the engine 110 of the power generation equipment before and after performing the vibration control is shown in FIG. 4. The horizontal axis of FIG. 4 is time and the measurement unit is second. The vertical axis of FIG. 4 is the acceleration of engine vibration and the measurement unit is meter per second squared (m/s²). In the time interval of FIG. 4, before performing the vibration control, the average vibration level of the engine 110 of the power generation equipment is 38.2 m/s². After performing the vibration control, the average vibration level of the engine 110 of the power generation equipment is 4.9 m/s². The vibration level of the engine 110 of the power generation equipment is greatly suppressed as illustrated in FIG. 4.

The order analysis results before and after performing the vibration control are illustrated in FIG. 5. The unit of the horizontal axis of FIG. 5 is order and order stands for the multiple of the rotation speed. For example, when the engine rotation speed during test is 3600 rpm, the vibration frequency corresponding to the first order is 60 Hertz (Hz), and the vibration frequency corresponding to the second order is 120 Hz. The vertical axis of FIG. 5 is the acceleration of engine vibration and the measurement unit is m/s². As the test result of 3500 rpm shown in FIG. 5, before performing the vibration control, the vibration in root mean square (rms) corresponding to orders of 0.5th, 1st, 1.5th, and 2nd are 11.8, 20.7, 5.7, and 14.3 m/s², respectively. After performing the vibration control, the vibration in rms corresponding to orders of 0.5th, 1st, 1.5th, and 2nd are 1.0, 1.3, 0.2, and 0.7 m/s², respectively. Vibration of the engine 110 of the power generation equipment is prominently suppressed in every major order.

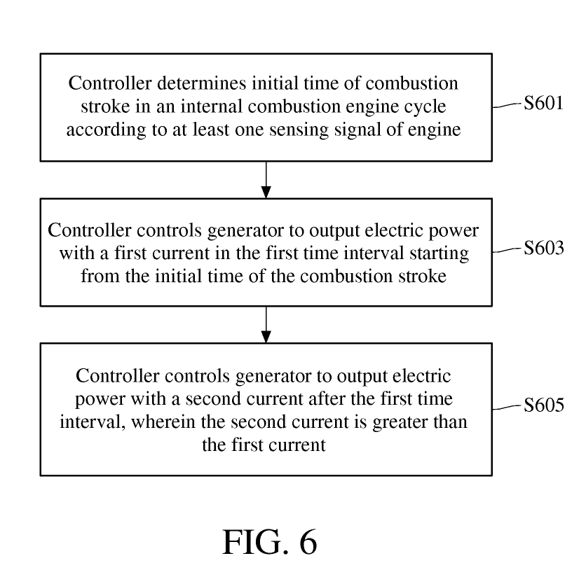

In fact, a control method of the power generation equipment is provided corresponding to the power generation equipment 100, and the method is adapted for the power generation equipment using an engine to drive a generator. Please refer to FIG. 6. FIG. 6 is a flowchart of the control method of the power generation equipment according to an embodiment. In the step S601, the controller determines an initial time of a combustion stroke in an internal combustion engine cycle according to at least one sensing signal of the engine. In the step S603, the controller controls the generator to output electric power with a first current in a first time interval starting from the initial time of the combustion stroke. In the step S605, the controller controls the generator to output electric power with a second current after the first time interval, wherein the second current is greater than the first current.

In the power generation equipment control method, the at least one sensing signal can be an ignition signal of the engine 110, a fuel injection signal of the engine 110, a signal from a crankshaft position sensor and a camshaft position sensor of the engine 110, a signal from an air intake pressure sensor of the engine 110, or a cylinder pressure signal of the engine 110. In an embodiment, the first current is zero. In addition, the duration of the first time interval is related to a rotation speed and the number of cylinders for controlling of vibration. In another embodiment, the method further includes determining the second current according to a preset current value and the duration of the first time interval.

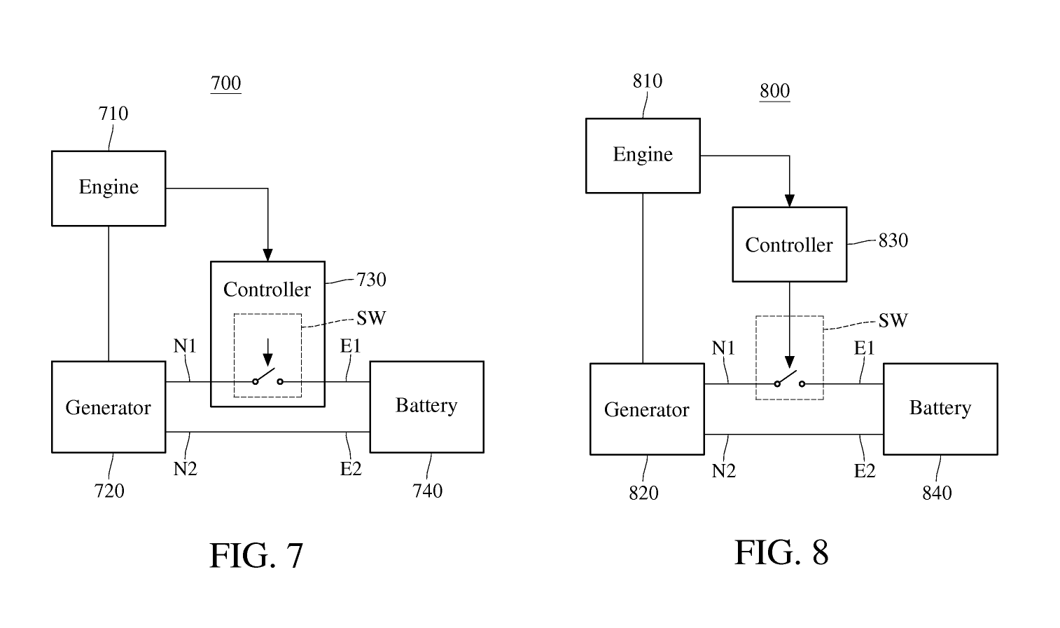

In addition, two range extenders 700, 800 are further extended from the power generation equipment 100. Please refer to FIG. 7 and FIG. 8 for the range extenders. FIG. 7 is a functional block diagram of the range extender 700 according to an embodiment. FIG. 8 is a functional block diagram of the range extender 800 according to another embodiment. As shown in FIG. 7, the range extender 700 includes a battery 740, an engine 710, a generator 720, and a controller 730. The generator 720 is coupled to the engine 710 and is electrically connected to the battery 740. The controller 730 is electrically connected to the engine 710 and the generator 720.

The battery 740 is for storing electric power and driving range extended electric vehicles, hybrid electric vehicles, or plug-in hybrid electric vehicles with the stored electric power. The engine 710 is for outputting kinetic power. The generator 720 is driven by the kinetic power output from the engine 710 to transform the kinetic power into electric power to charge the battery 740. The controller 730 is for determining the initial time of the combustion stroke in an internal combustion engine cycle according to at least one sensing signal related to the engine 710, controlling the generator 720 to charge the battery 740 with the first current in the first time interval starting from the initial time of the combustion stroke, and controlling the generator 720 to charge the battery 740 with the second current after the first time interval, wherein the second current is greater than the first current.

In addition, as shown in FIG. 7 and FIG. 8, the range extenders 700, 800 further include a switch SW. The generator 720 is electrically connected to the battery 740 through the switch SW, and the switch SW is controlled by the controller for selective conduction. In the embodiment corresponding to FIG. 7, the switch SW is designed at the interior of the controller 730. The generator 720 has a first output terminal N1 and a second output terminal N2, and the battery 740 has a first electrode E1 and a second electrode E2. The controller 730 is coupled between the first output terminal N1 and the first electrode E1 through the switch SW, and the second output terminal N2 is coupled to the second electrode E2. The controller 730 controls the switch SW not to conduct in the first time interval T1 and to conduct in the second time interval T2. The specific details are explained before and are not further described hereinafter. In another embodiment, the controller 730 is coupled between the second output terminal N2 and the second electrode E2 through the switch SW, and the first output terminal N1 is coupled to the first electrode E1.

In the embodiment corresponding to FIG. 8, the switch SW is outside the controller 830. The switch SW is coupled between the first output terminal N1 and the first electrode E1, or the switch SW is coupled between the second output terminal N2 and the second electrode E2. The controller 830 is coupled to the switch SW and is not directly coupled between the generator 820 and the battery 840. The other related actuations of the range extenders 700 and 800 can be deduced by analogy from the power generation equipment 100, and are not further explained hereinafter.

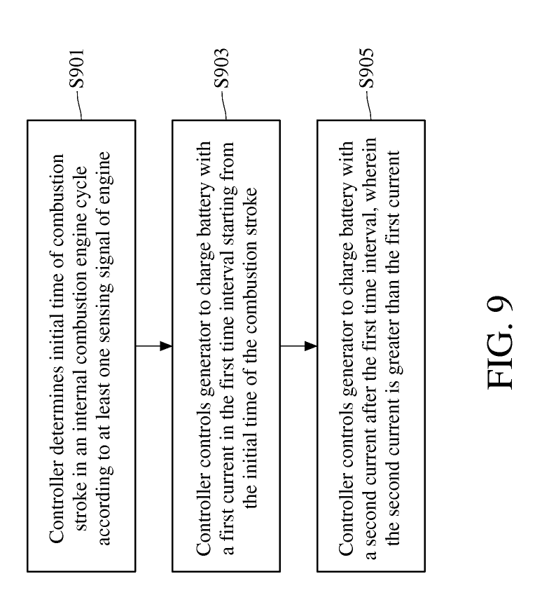

Corresponding to the range extenders 700 and 800, a charging control method is further provided for range extended electric vehicles. Please refer to FIG. 9. FIG. 9 is a flowchart of the charging control method of the range extender according to an embodiment. The range extender includes a battery, an engine, a generator, and a controller. The engine drives the generator to charge the battery. In the step S901, the controller determines an initial time of a combustion stroke in an internal combustion engine cycle according to at least one sensing signal of the engine. In the step S903, the controller controls the generator to charge the battery with a first current in a first time interval starting from the initial time of the combustion stroke. In the step S905, the controller controls the generator to charge the battery with a second current after the first time interval. In an embodiment, the first current is zero. In another embodiment, the first current is set to zero by cutting off an electrical connection between the generator and the battery.

A power generation equipment, a control method for a power generation equipment, a range extender and a charging control method are provided. By determining the event time of the maximum torque according to the sensing signal of the engine and correspondingly defining different time intervals, different generated currents are output in different time intervals. Accordingly, modification for the original design of the power generation equipment is avoided, and additional sensors and estimation of the engine torque value are not needed. Moreover, different systems are ready to use after only calibration once. The advantages of light weight, low cost, and simple design are satisfied at the same time.

The foregoing description has been presented for purposes of illustration. It is not exhaustive and does not limit the disclosure to the precise forms or embodiments disclosed. Modifications and adaptations will be apparent to those skilled in the art from consideration of the specification and practice of the disclosed embodiments of the disclosure. It is intended, therefore, that the specification and examples be considered as exemplary only, with a true scope and spirit of the disclosure being indicated by the following claims and their full scope of equivalents.

What is claimed is:

1. A control method for a power generation equipment having an engine to drive a generator, comprising:
determining an initial time of a combustion stroke in an internal combustion engine cycle according to at least one sensing signal of the engine;
controlling the generator to output electric power with a first current in a first time interval starting from the initial time of the combustion stroke; and
controlling the generator to output electric power with a second current after the first time interval.

2. The method of claim 1, wherein the second current is greater than the first current.

3. The method of claim 1, wherein the at least one sensing signal can be an ignition signal of the engine, a fuel injection signal of the engine, a signal from a crankshaft position sensor and a camshaft position sensor of the engine, a signal from an air intake pressure sensor of the engine, or a cylinder pressure signal of the engine.

4. The method of claim 1, wherein the first current is zero.

5. The method of claim 1, wherein the duration of the first time interval is related to a rotation speed and the number of cylinders for controlling of vibration.

6. The method of claim 1, further comprising determining the second current according to a preset current value and the duration of the first time interval.

7. The method of claim 1, wherein when the engine of the power generation equipment has two or more cylinders, controlling output electric power for each of the combustion stroke of a certain cylinder, part of the cylinders, or all of the cylinders is performed.

8. A power generation equipment, comprising:
an engine configured to output kinetic power;
a generator coupled to the engine, is configured to transform kinetic power output from the engine into electric power; and
a controller electrically connected to the engine and the generator, is configured to determine an initial time of a combustion stroke in an internal combustion engine cycle according to at least one sensing signal of the engine, to control the generator to output electric power with a first current in a first time interval starting from the initial time of the combustion stroke, and to control the generator to output electric power with a second current after the first time interval.

9. The power generation equipment of claim 8, wherein the second current is greater than the first current.

10. The power generation equipment of claim 8, wherein the at least one sensing signal can be an ignition signal of the engine, a fuel injection signal of the engine, a signal from a crankshaft position sensor and a camshaft position sensor of the engine, a signal from an air intake pressure sensor of the engine, or a cylinder pressure signal of the engine.

11. The power generation equipment of claim 8, wherein the first current is zero.

12. The power generation equipment of claim 8, wherein the duration of the first time interval is related to a rotation speed and the number of cylinders for controlling of vibration.

13. The power generation equipment of claim 8, wherein the controller further determines the second current according to a preset current value and the duration of the first time interval.

14. The power generation equipment of claim 8, wherein when the engine of the power generation equipment has two or more cylinders, controlling output electric power for each of the combustion stroke of a certain cylinder, part of the cylinders, or all of the cylinders is performed.

15. A charging control method for a range extender, the range extender having a battery, an engine, a generator, and a controller, the engine driving the generator to charge the battery, the method comprising:
the controller determining an initial time of a combustion stroke in an internal combustion engine cycle according to at least one sensing signal of the engine;
the controller controlling the generator to charge the battery with a first current in a first time interval starting from the initial time of the combustion stroke; and
the controller controlling the generator to charge the battery with a second current after the first time interval.

16. The method of claim 15, wherein the second current is greater than the first current.

17. The method of claim 15, wherein the at least one sensing signal can be an ignition signal of the engine, a fuel injection signal of the engine, a signal from a crankshaft position sensor and a camshaft position sensor of the engine, a signal from an air intake pressure sensor of the engine, or a cylinder pressure signal of the engine.

18. The method of claim 15, wherein the first current is zero.

19. The method of claim 18, wherein the first current is set to zero by cutting off an electrical connection between the generator and the battery.

20. The method of claim 15, wherein the duration of the first time interval is related to a rotation speed and the number of cylinders for controlling vibration.

21. The method of claim 15, further comprising determining the second current according to a preset current value and the duration of the first time interval.

22. The method of claim 15, wherein when the engine of the power generation equipment has two or more cylinders, controlling output electric power for charging the battery for each of the combustion stroke of a certain cylinder, part of the cylinders, or all of the cylinders is performed.

23. A range extender, comprising:
a battery configured to store electric power and to drive a range extended electric vehicle, or a hybrid electric vehicle, or a plug-in hybrid electric vehicle with stored electric power;
an engine configured to output kinetic power;
a generator coupled to the engine and electrically connected to the battery, is configured to transform kinetic power output from the engine into electric power to charge the battery; and
a controller electrically connected to the engine and the generator, is configured to determine an initial time of a combustion stroke in an internal combustion engine cycle according to at least one sensing signal of the engine, to control the generator to charge the battery with a first current in a first time interval starting from the initial time of the combustion stroke, and to control the generator to charge the battery with a second current after the first time interval.

24. The range extender of claim 23, wherein the second current is greater than the first current.

25. The range extender of claim 23, wherein the at least one sensing signal can be an ignition signal of the engine, a fuel injection signal of the engine, a signal from a crankshaft position sensor and a camshaft position sensor of the engine, a signal from an air intake pressure sensor of the engine, or a cylinder pressure signal of the engine.

26. The range extender of claim 23, wherein the first current is zero.

27. The range extender of claim 23, further comprising a switch, the generator electrically connected to the battery through the switch, and the switch controlled by the controller for selective conduction.

28. The range extender of claim 23, wherein the generator has a first output terminal and a second output terminal, and the battery has a first electrode and a second electrode, and the first output terminal of the generator is connected to the first electrode of the battery, and the controller comprises:
a switch, wherein a first terminal of the switch is connected to the second output terminal, and a second terminal of the switch is connected to the second electrode, and the switch is not conducted in the first time interval and is conducted after the first time interval.

29. The range extender of claim 23, wherein the duration of the first time interval is related to a rotation speed and the number of cylinders for controlling of vibration.

30. The range extender of claim 23, wherein the controller further determines the second current according to a preset current value and the duration of the first time interval.

31. The range extender of claim 30, wherein the second current is less than the preset current value and power generation control gradually increases or gradually decreases electric power to reach the preset current value in a set time interval when the generator wants to perform power generation activation or deactivation procedure.

32. The range extender of claim 23, wherein when the engine of the power generation equipment has two or more cylinders, controlling output electric power for charging the battery for each of the combustion stroke of a certain cylinder, part of the cylinders, or all of the cylinders is performed.
